(19) United States
(12) Patent Application Publication
(10) Pub. No.: US 2018/0354705 A1
(43) Pub. Date: Dec. 13, 2018

(54) Adjustably Bottomed Container

(71) Applicant: Raymond Hershberger, Huntsburg, OH (US)

(72) Inventor: Raymond Hershberger, Huntsburg, OH (US)

(21) Appl. No.: 15/616,515

(22) Filed: Jun. 7, 2017

(51) Int. Cl. B65D 83/00; B44D 3/12; B65D 25/28

(52) U.S. Cl. CPC B65D 83/0005; B65D 25/2835; B44D 3/127

(57) ABSTRACT

An adjustably bottomed container for maximizing usage of the contents of the container includes a cylinder that defines an internal space. The cylinder has a top and a bottom. The top and the bottom are open. A plate, which is complementary to an internal circumference of the cylinder, is slidably couplable to an interior surface of the cylinder. The plate is configured to be pushed from the bottom toward the top of the cylinder. Contents that are positioned in the internal space, such as paint, are compelled toward the top.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

Description of Related Art including information disclosed under 37 CFR 1.97 and 1.98

The disclosure and prior art relates to containers and more particularly pertains to a new container for maximizing usage of the contents of the container.

### BRIEF SUMMARY OF THE INVENTION

An embodiment of the disclosure meets the needs presented above by generally comprising a cylinder that defines an internal space. The cylinder has a top and a bottom. The top and the bottom are open. A plate, which is complementary to an internal circumference of the cylinder, is slidably couplable to an interior surface of the cylinder. The plate is configured to be pushed from the bottom toward the top of the cylinder. Contents that are positioned in the internal space, such as paint, are compelled toward the top.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an adjustably bottomed container according to an embodiment of the disclosure.

FIG. 2 is a side view of an embodiment of the disclosure.

FIG. 3 is a detail view of an embodiment of the disclosure.

FIG. 4 is a cross-sectional view of an embodiment of the disclosure.

FIG. 5 is a bottom view of an embodiment of the disclosure.

### DETAILED DESCRIPTION OF THE INVENTION

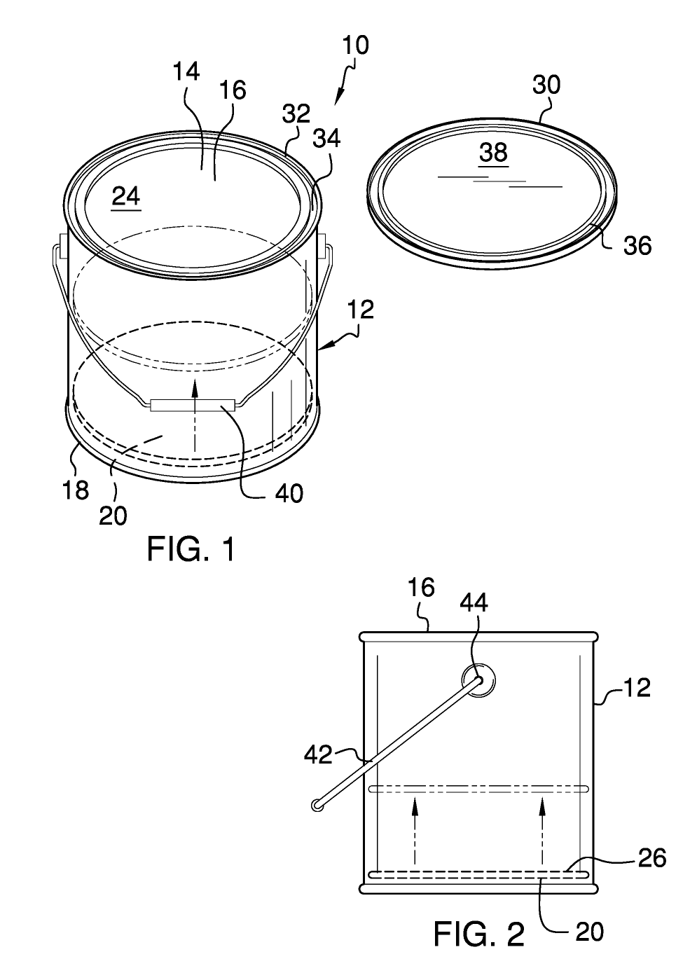

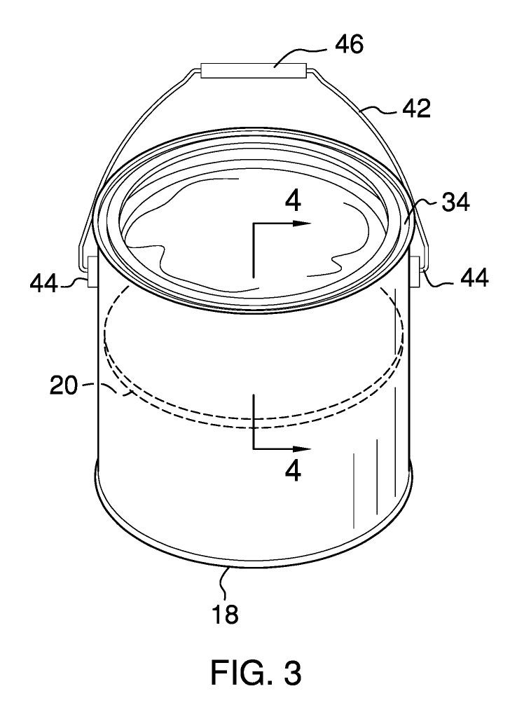

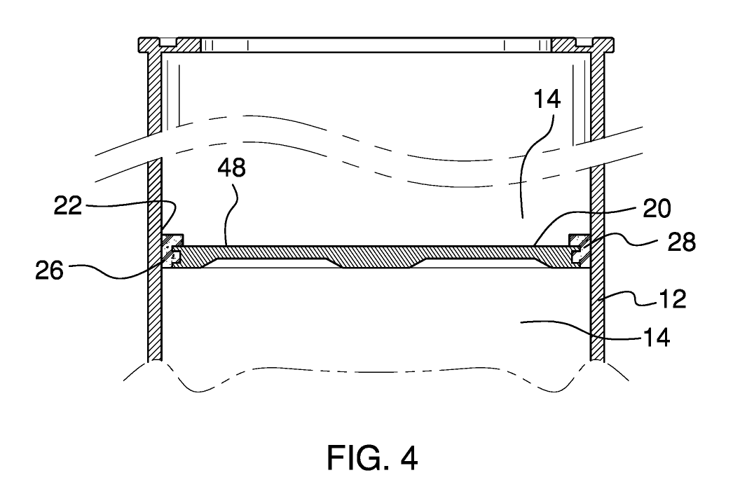

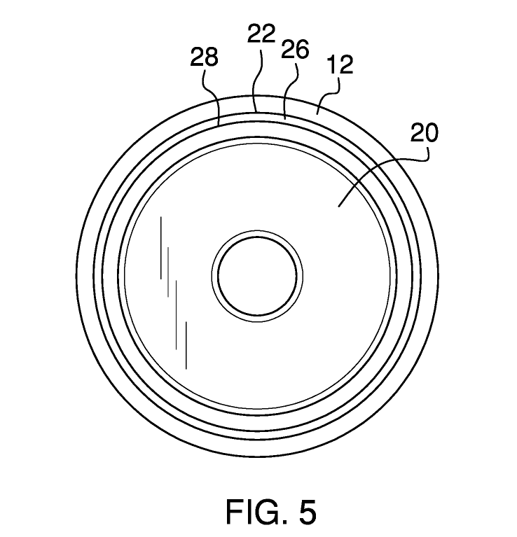

With reference now to the drawings, and in particular to FIGS. 1 through 5 thereof, a new container embodying the principles and concepts of an embodiment of the disclosure and generally designated by the reference numeral 10 will be described.

As best illustrated in FIGS. 1 through 5, the adjustably bottomed container 10 generally comprises a cylinder 12 that defines an internal space 14. The cylinder 12 has a top 16 and a bottom 18. The top 16 and the bottom 18 are open. In one embodiment, the cylinder 12 is substantially circularly shaped when viewed from the top 16.

The container 10 comprises a plate 20 that is complementary to an internal circumference 22 of the cylinder 12. The plate 20 is slidably couplable to an interior surface 24 of the cylinder 12. The plate 20 is configured to be pushed from the bottom 18 toward the top 16. Contents that are positioned in the internal space 14, such as paint, are compelled toward the top 16 of the cylinder 12.

In one embodiment, a gasket 26 is coupled to and extends radially from a perimeter 28 of the plate 20. The gasket 26 is positioned to sealably couple to the interior surface 24 of the cylinder 12 to selectively position the plate 20 between the bottom 18 and the top 16 of the cylinder 12. The gasket 26 is configured to retain the contents of the internal space 14 above the plate 20. In another embodiment, the gasket 26 extends vertically from the perimeter to protrude past an upper face 48 of the plate 20. The gasket 26 is positioned to abut the interior surface 24 so that the plate 20 is retained parallel to the bottom 18 and the top 16 as the plate 20 is selectively positioned between the bottom 18 and the top 16 of the cylinder 12.

In one embodiment, the container 10 comprises a lid 30 that is complementary to the top 16 and reversibly couplable to the cylinder 12. The lid 30 is positioned to be removed to allow access to the contents that are positioned in the internal space 14. The lid 30 is positioned to couple to the cylinder 12 to close the top 16 to retain the contents within the internal space 14.

In another embodiment, a lip 32 is coupled to the top 16 of the cylinder 12. The lip 32 defines a channel 34. A protrusion 36 is coupled to and extends from a lower face 38 of the lid 30. The protrusion 36 is complementary to the channel 34. The channel 34 is positioned to selectively insert the protrusion 36 to couple the lid 30 to the cylinder 12 to close the top 16.

In one embodiment, the container 10 comprises a handle 40. The handle 40 is coupled to the cylinder 12 proximate to the top 16. The handle 40 is configured to be grasped in a hand of a user to position the cylinder 12 in a desired position. In another embodiment, the handle 40 comprises a wire 42 that has opposing ends 44. Each opposing end 44 is pivotally coupled to the cylinder 12. The opposing ends 44 are opposingly positioned on the cylinder 12. In yet another embodiment, a tube 46 is positioned around the wire 42. The tube 46 is positioned equally distant from the opposing ends 44 of the wire 42. The tube 46 is configured to be grasped in the hand of the user while the wire 42 is allowed to rotate within the tube 46.

In use the handle 40 is configured to be grasped in the hand of the user to position the cylinder 12 in the desired position. The lid 30 is positioned to be removed to allow access to the contents, such as the paint, that are positioned in the internal space 14. The plate 20 is configured to be pushed from the bottom 18 toward the top 16. The contents that are positioned in the internal space 14 are compelled toward the top 16. The gasket 26 that is positioned on the plate 20 is positioned to sealably couple to the interior surface 24 of the cylinder 12 to selectively position the plate 20 between the bottom 18 and the top 16 of the cylinder 12. The gasket 26 is positioned to abut the interior surface 24 so that the plate 20 is retained parallel to the bottom 18 and the top 16 as the plate 20 is selectively positioned between the bottom 18 and the top 16 of the cylinder 12. The gasket 26 is configured to retain the contents of the internal space 14 above the plate 20. The lid 30 is positioned to couple to the cylinder 12 to close the top 16 to retain the contents within the internal space 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An adjustably bottomed container comprising:
a cylinder defining an internal space, said cylinder having a top and a bottom, said top and said bottom being open;
a plate complementary to an internal circumference of said cylinder, said plate being slidably couplable to an interior surface of said cylinder; and
wherein said plate is positioned in said cylinder such that said plate is configured for pushing from said bottom toward said top such that contents positioned in said internal space, such as paint, are compelled toward said top.

2. The container of claim 1, further including said cylinder being substantially circularly shaped when viewed from said top.

3. The container of claim 1, further including a gasket coupled to and extending radially from a perimeter of said plate, wherein said gasket is positioned on said plate such that said gasket is positioned for sealably coupling to said interior surface of said cylinder for selectively positioning said plate between said bottom and said top of said cylinder, and wherein said gasket is configured for retaining the contents of said internal space above said plate.

4. The container of claim 3, further including said gasket extending vertically from said perimeter such that said gasket protrudes past an upper face of said plate, wherein said gasket is positioned on said plate such that said gasket is positioned for abutting said interior surface such that said plate is retained parallel to said bottom and said top as said plate is selectively positioned between said bottom and said top of said cylinder.

5. The container of claim 1, further including a lid complementary to said top and reversibly couplable to said cylinder, wherein said lid is positioned on said top such that said lid is positioned for removing for accessing the contents positioned in said internal space, and wherein said lid is positioned for coupling to said cylinder for closing said top for retaining the contents within said internal space.

6. The container of claim 5, further comprising:
a lip coupled to said top of said cylinder defining a channel;
a protrusion coupled to and extending from a lower face of said lid, said protrusion being complementary to said channel; and
wherein said channel is positioned on said cylinder such that said channel is positioned for selectively inserting said protrusion for coupling said lid to said cylinder for closing said top.

7. The container of claim 1, further including a handle coupled to said cylinder proximate to said top, wherein said handle is positioned on said cylinder such that said handle is configured for grasping in a hand of a user for positioning said cylinder in a desired position.

8. The container of claim 7, further including said handle comprising a wire having opposing ends, each said opposing end being pivotally coupled to said cylinder such that said opposing ends are opposingly positioned on said cylinder.

9. The container of claim 8, further including a tube positioned around said wire, said tube being positioned equally distant from said opposing ends of said wire, wherein said tube is positioned on said wire such that said tube is configured for grasping in the hand of the user allowing said wire to rotate within said tube.

10. An adjustably bottomed container comprising:
a cylinder defining an internal space, said cylinder having a top and a bottom, said top and said bottom being open, said cylinder being substantially circularly shaped when viewed from said top;
a plate complementary to an internal circumference of said cylinder, said plate being slidably couplable to an interior surface of said cylinder, wherein said plate is positioned in said cylinder such that said plate is configured for pushing from said bottom toward said top such that contents positioned in said internal space, are compelled toward said top;
a gasket coupled to and extending radially from a perimeter of said plate, wherein said gasket is positioned on said plate such that said gasket is positioned for sealably coupling to said interior surface of said cylinder for selectively positioning said plate between said bottom and said top of said cylinder, and wherein said gasket is configured for retaining the contents of said internal space above said plate, said gasket extending vertically from said perimeter such that said gasket protrudes past an upper face of said plate, wherein said gasket is positioned on said plate such that said gasket is positioned for abutting said interior surface such that said plate is retained parallel to said bottom and said top as said plate is selectively positioned between said bottom and said top of said cylinder;
a lid complementary to said top and reversibly couplable to said cylinder, wherein said lid is positioned on said top such that said lid is positioned for removing for accessing the contents positioned in said internal space, and wherein said lid is positioned for coupling to said cylinder for closing said top for retaining the contents within said internal space;
a lip coupled to said top of said cylinder defining a channel;
a protrusion coupled to and extending from a lower face of said lid, said protrusion being complementary to said channel, wherein said channel is positioned on said cylinder such that said channel is positioned for selectively inserting said protrusion for coupling said lid to said cylinder for closing said top;
a handle coupled to said cylinder proximate to said top, wherein said handle is positioned on said cylinder such that said handle is configured for grasping in a hand of a user for positioning said cylinder in a desired position, said handle comprising a wire having opposing ends, each said opposing end being pivotally coupled to said cylinder such that said opposing ends are opposingly positioned on said cylinder;
a tube positioned around said wire, said tube being positioned equally distant from said opposing ends of said wire, wherein said tube is positioned on said wire such that said tube is configured for grasping in the hand of the user allowing said wire to rotate within said tube; and
wherein said handle is positioned on said cylinder such that said handle is configured for grasping in the hand of the user for positioning said cylinder in the desired position, wherein said lid is positioned on said top such that said lid is positioned for removing for accessing the contents positioned in said internal space, wherein said plate is positioned in said cylinder such that said plate is configured for pushing from said bottom toward said top such that the contents positioned in said internal space are compelled toward said top, wherein said gasket is positioned on said plate such that said gasket is positioned for sealably coupling to said interior surface of said cylinder for selectively positioning said plate between said bottom and said top of said cylinder, wherein said gasket is positioned for abutting said interior surface such that said plate is retained parallel to said bottom and said top as said plate is selectively positioned between said bottom and said top of said cylinder, wherein said gasket is configured for retaining the contents of said internal space above said plate, wherein said lid is positioned for coupling to said cylinder for closing said top for retaining the contents within said internal space.
